(19) United States
(12) Patent Application Publication
(10) Pub. No.: US 2026/0352946 A1
(43) Pub. Date: Nov. 5, 2026

(54) IMAGING APPARATUS, CONTROL METHOD THEREFOR, AND MEDIUM

(71) Applicant: CANON KABUSHIKI KAISHA, Tokyo (JP)

(72) Inventor: TOMONORI IIDA, Tokyo (JP)

(21) Appl. No.: 19/665,183

(22) Filed: May 1, 2026

(30) Foreign Application Priority Data
May 2, 2025 (JP) 2025-076872

(51) Int. Cl. H04N 23/60; G06F 40/56; H04N 23/667; H04N 23/67; H04N 23/73

(52) U.S. Cl. CPC H04N 23/64; G06F 40/56; H04N 23/667; H04N 23/67; H04N 23/73

(57) ABSTRACT

An imaging apparatus generates control information according to a shooting setting of the imaging device; and generates a caption according to an image shot by the imaging device and the control information.

### BACKGROUND

### Field of the Technology

The technology of the present disclosure relates to an imaging apparatus, a control method therefor, and a medium, and particularly relates to, for example, caption generation by artificial intelligence such as a neural network that integrally processes a plurality of data as an input.

### Description of the Related Art

In recent years, image summary (caption) generation by artificial intelligence (AI) using a neural network or the like has attracted attention as a method capable of achieving text search for images due to high generation accuracy. Since the convenience of the text search for images improves as the accuracy of caption generation increases, various AI caption generation technologies have been devised so far. For example, Japanese Patent Application Laid-Open No. 2020-13427 discloses a method of increasing caption accuracy by extracting a global feature and a local feature from an image, identifying a region of interest from the two features, and weighting the region.

However, even if the technology described in Japanese Patent Application Laid-Open No. 2020-13427 is used, there is a problem in that in a case where a situation cannot be determined from an image, a generated caption deviates from a shooting intention, and the accuracy thereof decreases.

### SUMMARY

Therefore, an imaging apparatus is provided that makes it possible to generate a high-accuracy caption for an image by using shooting settings of the imaging apparatus at the time of shooting.

One aspect of the present disclosure provides an imaging apparatus comprising: an imaging device; at least one memory storing instructions; and at least one processor that is in communication with the at least one memory and that, when executing the instructions, cooperates with the at least one memory to execute processing, the processing including generating control information according to a shooting setting of the imaging device; and generating a caption according to an image shot by the imaging device and the control information.

According to the above configuration, a high-accuracy caption can be generated for an image by using the shooting settings of the imaging apparatus.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a hardware configuration diagram in a first embodiment

FIG. 2 is a conceptual configuration diagram in the first embodiment

FIG. 3A is an image diagram of a caption in a case of shooting in a person mode in the first embodiment

FIG. 3B is an image diagram of a caption in a case of shooting in a landscape mode in the first embodiment

FIG. 3C is an image diagram of a caption in a case of shooting in a sports mode in the first embodiment

FIG. 4 is an operation flowchart in the first embodiment

FIG. 5 is a conceptual configuration diagram in a second embodiment

FIG. 6 is a table configuration diagram in the second embodiment

FIG. 7A is an image diagram of a caption in a case where an index value is “small” in the “person mode” in the second embodiment

FIG. 7B is an image diagram of a caption in a case where the index value is “medium” in the “person mode” in the second embodiment

FIG. 7C is an image diagram of a caption in a case where the index value is “large” in the “person mode” in the second embodiment

FIG. 8 is an operation flowchart in the second embodiment

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Embodiment 1

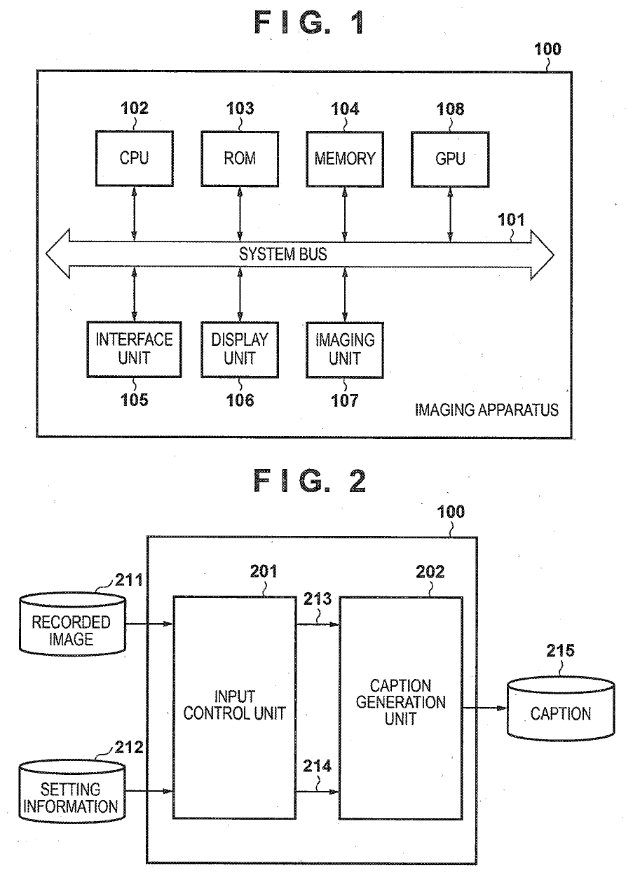

Hereinafter, an imaging apparatus according to a first embodiment will be described with reference to FIG. 1 to FIG. 4.
Configuration of apparatus

FIG. 1 is a diagram showing a hardware configuration example of the imaging apparatus in the present embodiment. An imaging apparatus 100 may be, for example, a digital camera that forms an image on an imaging device such as a CCD or a CMOS sensor by an optical system and saves image data digitized by the imaging device.

The imaging apparatus 100 includes a CPU 102, a ROM 103, a memory 104, an interface unit 105, a display unit 106, an imaging unit 107, and a GPU 108 connected to a system bus 101. Each unit connected to the system bus 101 is configured to be able to exchange data with each other via the system bus 101. The imaging apparatus 100 saves an image acquired by the imaging unit 107 in a storage (not shown) in response to a user instruction obtained from the interface unit 105.

The ROM 103 stores various programs executed by the CPU 102. Note that the various programs executed by the CPU 102 are not limited to the ROM and may be stored in, for example, a hard disk or the like. The ROM 103 is read-only, but may be an erasable and rewritable ROM.

The memory 104 is composed of, for example, a RAM. The CPU 102 and the GPU 108 use the memory 104 as a work memory according to programs stored in the ROM 103. Alternatively, a program stored in the ROM 103 may be loaded into the memory 104 and executed.

The interface unit 105 receives a user operation, generates a control signal according to the operation, and supplies the control signal to the CPU 102. For example, the interface unit 105 includes a physical operation button, an operation dial, a touch panel, or the like as an input device that receives a user operation. Note that the touch panel is an input device configured to output coordinate information according to a position touched on, for example, an input unit configured in a planar manner.

The CPU 102 executes programs stored in the ROM 103 or the memory 104 and controls the display unit 106, the imaging unit 107, and the like based on, for example, a control signal supplied according to a user operation performed from the interface unit 105. Thus, the display unit 106 and the imaging unit 107 can be caused to perform operations according to user operations. Note that this is not limited to the display unit 106 and the imaging unit 107, and other devices such as the interface unit 105 can also be controlled. Furthermore, the CPU 102 can provide input parameters to the GPU 108, cause the GPU 108 to execute processing according to the input parameters, and obtain an output.

The GPU 108 is an abbreviation for Graphics Processing Unit and is an arithmetic unit capable of performing processing specialized for computer graphic calculations. The GPU 108 is generally capable of performing calculations required for a neural network, such as matrix calculations, in a shorter time than the CPU 102. Note that in addition to the GPU 108 or instead of the GPU 108, a neural processing unit (NPU) for performing calculations required for the neural network may be provided.

The display unit 106 is, for example, a display and includes a mechanism for outputting a display signal for causing the display to display an image. Note that in a case where a touch panel is used as the interface unit 105, the interface unit 105 and the display can be integrally configured. For example, the touch panel is configured such that light transmittance does not interfere with the displaying of the display, and is attached to an upper layer of a display surface of the display. Then, the touch panel can be configured by associating input coordinates on the touch panel with display coordinates on the display.

The imaging unit 107 is a mechanism that performs a series of shooting processes and that includes a lens, a shutter having an aperture function, an imaging unit composed of a CCD or CMOS element that converts an optical image into an electrical signal, and an image processing unit that performs various image processing such as exposure control and distance measurement control from a signal of the imaging unit. Based on control of the CPU 102, shooting according to a user operation of the interface unit 105 is possible. The imaging unit 107 may be referred to as a camera or a camera unit.

FIG. 2 shows a conceptual diagram of the structure of the imaging apparatus 100. The imaging apparatus 100 includes an input control unit 201 and a caption generation unit 202.

Processing of the input control unit 201 and the caption generation unit 202 is realized by the CPU 102 and the GPU 108 executing programs. The input control unit 201 receives a shooting instruction signal from the interface unit 105, acquires a recorded image 211 to be shot and setting information 212 at the time of shooting, and outputs them to the caption generation unit 202 as an image 213 and control information 214. Since the input control unit 201 generates and outputs the control information 214, it may be referred to as a control information generation unit. The control information 214 is also referred to as caption control information. The recorded image 211 and the image 213 may be the same data, or for example, a resized recorded image 211 may be used as the image 213. Alternatively, the image 213 may not be the image itself but may be feature data obtained by extracting features from the recorded image 211. Furthermore, this feature data may include either or both of a global feature of the entire image and a local feature obtained by dividing the image into partial regions and extracting features for each partial region.

The setting information 212 is, for example, a shooting mode (e.g., “person mode”, “landscape mode”, etc.) of the camera when shooting the recorded image 211. Like the setting information 212, the control information 214 may be information indicating the shooting mode, or may be information uniquely determined from the information indicating the shooting mode (e.g., “focus on person”, “focus on landscape”, etc.). Conversion from the information indicating the shooting mode to the uniquely determined information is possible by, for example, the input control unit 201 holding information such as a table in which the shooting mode and converted information are associated with each other and performing conversion by referring to the table. By converting information in accordance with the processing of the caption generation unit 202, it is possible to aim for improvement in the accuracy of the caption generated by the caption generation unit 202. In the present embodiment, description will be given assuming that the recorded image 211 and the image 213 are the same data and the setting information 212 and the control information 214 are the same data.

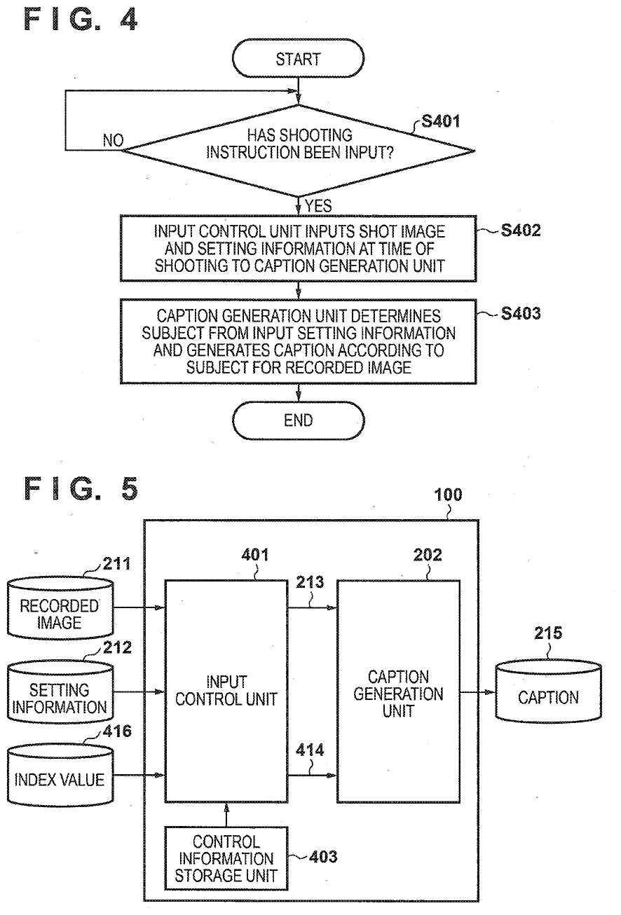

The caption generation unit 202 generates caption information 215 for the recorded image from the image 213 shot in response to the shooting instruction signal from the interface unit 105 and the control information 214. The caption information is, for example, an explanatory text of the image, and by associating the caption information with the recorded image and saving it in, for example, the memory 104, it becomes possible to search for or organize images by text. The caption generation unit 202 assumes a neural network. Specific processing contents of the input control unit 201 and the caption generation unit 202 will be described later with reference to FIG. 4.

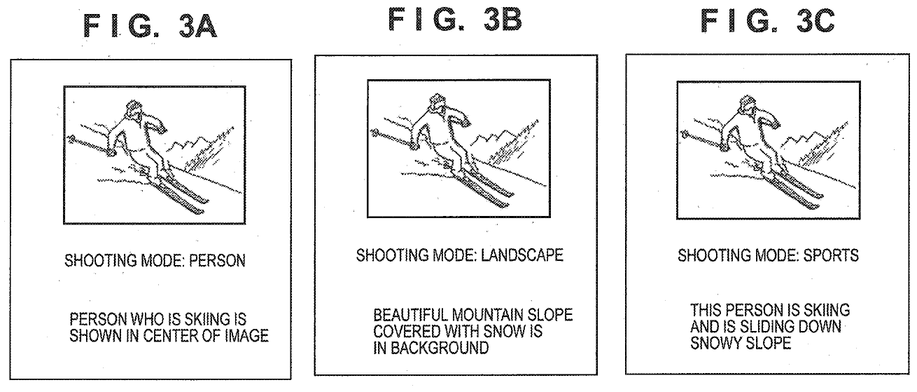

Here, a feature of the present embodiment is that the imaging apparatus 100 inputs the control information 214 together with the image 213 to the caption generation unit 202 to generate a caption of the recorded image. FIG. 3A to FIG. 3C show image diagrams representing a relationship among the image 213, the control information 214, and the caption information 215 in the present embodiment. FIG. 3A shows a caption example in a case of shooting in a person mode, which is a shooting mode in which a person is a subject, that is, a main subject. FIG. 3B shows a caption example in a case of shooting in a landscape mode, which is a shooting mode in which a landscape is a subject. FIG. 3C shows a caption example in a case of shooting in a sports mode, which is a shooting mode in which a sports scene or a motion of an object such as a person is a subject. In the case of FIG. 3A, the caption generation unit 202 determines that the subject is a person based on the setting information 212 including the shooting mode or the control information 214 generated therefrom, and generates a caption “a person who is skiing is shown in the center of the image”. Similarly, in the case of FIG. 3B, the caption generation unit 202 similarly determines that the subject is a landscape and generates a caption “a beautiful mountain slope covered with snow is in the background”. In the case of FIG. 3C, the caption generation unit 202 similarly determines that the subject is a motion and generates a caption “this person is skiing and is sliding down a snowy slope”. In the caption generation unit 202, artificial intelligence (AI) using a machine learning model is used as outlined below. A trained model thereof is trained to receive the image and the setting information such as the shooting mode or information generated from the setting information as input and generate a caption in accordance with the setting information as described above.

In a conventional caption generation method using AI, caption generation is performed using this single image 213. Therefore, as shown in each of FIG. 3A to FIG. 3C, it is difficult to uniquely determine the subject, and for example, based on information of each of a person, a landscape, and a motion included in the image, a caption explaining all of them is obtained. Even if how much detail the description of the caption should have can be selected in the settings, the subject cannot be determined, and therefore a caption that explains unnecessary parts in light of the user intention is generated. For this reason, when performing text search for images targeting generated captions, there is a problem in that extra photos are also included in search results, resulting in poor search accuracy. By determining the subject and generating a caption related to the subject, the text search for images can be performed with high accuracy. Note that the improvement in the accuracy of the caption described in the present embodiment means making a caption intended by the user in order to improve the text search accuracy for images without unnecessarily increasing the number of characters.

In the present embodiment, by focusing on the setting information of the camera, it is possible to generate different captions for one image as shown in FIG. 3A to FIG. 3C. The captions in FIG. 3A to FIG. 3C are examples, and the gist of the present embodiment is to clarify the subject of the caption based on the setting information of the camera. In the generated caption, the determined subject may be used as a subject of a sentence, or description of the subject may be increased and description of things other than the subject may be concise (omitted) and not limited. This depends on the learning of the AI that generates the caption. Further, if there is information registered in advance, it is possible to generate a caption using the registered information, for example, a specific name (such as a person's name). This may be registered in advance and stored in the memory 104, or may be acquired by accessing external information using a network function (not shown), which is not limited. Regarding embedding of the registered information into the caption, if it is for a search purpose, it does not particularly need to be embedded so as to constitute a sentence, and a character string corresponding to the registration information may be simply added to the generated caption.

### Overview of Neural Network

Here, neural networks will be briefly described. A neural network is a machine learning mechanism and is composed of, for example, an input layer, one or more intermediate layers, and an output layer. In an example of such a typical configuration, each layer has a plurality of nodes, and a node is connected to one or more other nodes. Each node has a threshold and a weight as parameters, and when an output of a node in a certain layer exceeds the threshold, weighted data is transmitted to a node in the next layer. Such data propagation is performed from the input layer to which data is input, through the intermediate layers, and further to the output layer, to obtain an output. In the neural network, parameters such as thresholds and weighting of signals output from nodes are adjusted by learning, and when the adjustment is completed, the configuration of each layer and parameters such as weights are obtained as a trained model. Once the trained model is created, a processing result can be obtained from the output layer by inputting data to its input layer as described above.

When this is applied to the caption generation unit 202 of the present embodiment, inputs are the image 213 which is a recorded image or the like and the control information 214 obtained from the setting information 212. For example, sets of such images and the restriction information 214 serving as teacher data are prepared, a caption is obtained as an output, and an error between the caption obtained as the output and a correct caption, that is, a caption conforming to the user's shooting intention, is evaluated. The error can be evaluated based on, for example, the number of matching words used or a matching rate. If many words match or the rate is high, the evaluation is high and the error is small, and if the number of matching words is small or the rate is low, the evaluation is low and the error is large. Then, the parameters are adjusted to reduce the error, and learning is performed. The trained model obtained in this manner is held in the caption generation unit 202. Note that learning may be performed by the imaging apparatus 100, but here, learning may be performed by a computer or the like other than the imaging apparatus 100. Also, the caption generation unit 202 may not hold the trained model, and configuration may be such that a trained AI is configured using a service such as an external generative AI, and input information is provided to the service in the caption generation unit 202, and an outputted caption is acquired therefrom. Note that the AI used in the caption generation unit 202 of the present embodiment is not limited to a neural network. Furthermore, a method of generating a caption based on feature recognition of an image without using AI may be used.
Shooting processing

FIG. 4 shows an operation flow during shooting in the present embodiment. The processing in FIG. 4 may be executed, for example, when initialization processing or the like is completed after power-on and preparations for shooting are completed. Alternatively, it may be started triggered by a shooting instruction, for example, pressing of a release button, and in that case, it may be started from step S402. The processing in FIG. 4 is executed by the CPU 102, but the processing by the caption generation unit 202 may be executed by the GPU 108 or an NPU (not shown) in response to an instruction from the CPU 102.

In step S401, the CPU 102 determines whether a shooting instruction has been input from the interface unit 105. If the shooting instruction has been input, the process proceeds to step S402, and if the shooting instruction has not been input, the process proceeds to step S401. At this time, in the imaging unit 107, shooting is performed according to the setting information such as the shooting mode in response to the shooting instruction, and the shot image is saved in the memory 104 or the like as a recorded image.

In step S402, upon receiving the shooting instruction, the CPU 102 inputs the recorded image 211 acquired by the shooting instruction to the caption generation unit 202 as the image 213. Furthermore, the CPU 102 acquires the setting information 212 including the shooting mode of the imaging apparatus 100 when shooting the recorded image 211, and inputs it to the caption generation unit 202 as the control information 214 based on the setting information 212. The operation of step S402 corresponds to the operation of the input control unit 201. In a case where the shooting mode is used as the setting information, for example, text representing a subject associated with the shooting mode may be stored in advance in the memory 104 or the like, and the subject corresponding to the acquired shooting mode may be input to the caption generation unit 202 as the control information 214.

In step S403, the caption generation unit 202 generates and outputs a caption 215 according to subject information determined from the control information 214 for the image 213 from the input image 213 and control information 214. In a case where the caption generation unit 202 is realized by the GPU 108 or an NPU, the operation of step S403 is executed by the GPU 108 or the NPU. In the present embodiment, the caption generation unit 202 is realized by AI using a machine-learning trained model. Therefore, in step S403, the image 213 and the control information 214 are input to the trained model, and the caption is output by the trained model.

With the above, the description of the operation flow of the input control unit 201 and the caption generation unit 202 is ended.

As described here, in the present embodiment, the setting information 212 is assumed to be the shooting mode of the camera when shooting the recorded image 211. However, the setting information 212 is not limited to this. The setting information 212 may be setting information of the camera by which the user's intention can be understood. For example, it may be information on a subject tracked by an autofocus function for shooting (e.g., “person priority”, “animal priority”, “vehicle priority”, etc.) or information on a shutter speed at the time of shooting. In the former case, for example, if the autofocus function is “animal priority”, a caption with “animal” as the subject can be generated. For that purpose, for example, if the tracking target of the autofocus function is “animal priority”, control information including a character string “animal” indicating the subject is generated. Also, if it is “person priority”, restriction information including a character string “person” indicating the subject is generated, and if it is “vehicle priority”, control information including a character string “vehicle” indicating the subject is generated. In this way, control information is generated so as to have the subject priority setting as the subject, and by using it as an input to the caption generation unit 202, a caption conforming to the subject included in the target image can be generated. Such control information can be obtained by predefining control information according to a shooting setting, acquiring the shooting setting, and replacing it with corresponding control information.

In the latter case, for example, in a case where the shutter speed is slower than a specific threshold (such as 1/250 seconds), control information is generated indicating that the shooting subject is a person or an object being shown. On the other hand, in a case where the shutter speed is equal to or higher than the threshold, control information is generated indicating that the shooting subject is a motion of a subject such as a person or an object. By inputting the control information generated in this way into the caption generation unit 202 together with the image, captions each regarded as the subject can be generated. For generation of the control information, for example, control information such as a character string corresponding to a speed range of the shutter speed is predetermined and stored in the memory 104, control information corresponding to the shutter speed is specified, and it may be used as an input to the caption generation unit 202. In this way, a caption conforming to the subject can be generated.

As described above, in the first embodiment, the image 213 based on the recorded image 211 and the restriction information 214 corresponding to the setting information 212 are each input to the caption generation unit 202 by the input control unit 201. High-accuracy caption generation is made possible by the caption generation unit 202 inputting each piece of input information to the trained model.

### Embodiment 2

A second embodiment will be described below. A conceptual configuration diagram and a processing flow, which are contents different from those of the first embodiment, will be described, and description of common contents will be omitted.

FIG. 5 shows a conceptual configuration diagram of the imaging apparatus 100 in the present embodiment. The imaging apparatus 100 newly includes a control information storage unit 403 compared to the first embodiment. The control information storage unit 403 is provided in the memory 104 and controlled by an input control unit 401, and processing of the input control unit 401 is realized by a program operating by the CPU 102 or the GPU 108.

The input control unit 401 receives a shooting instruction signal from the interface unit 105, acquires a shot recorded image 211, setting information 212 at the time of shooting, and an index value 416, and outputs an image 213 and control information 414 to the caption generation unit 202. The control information 414 is information acquired from the control information storage unit 403 based on the setting information 212 and the index value 416.

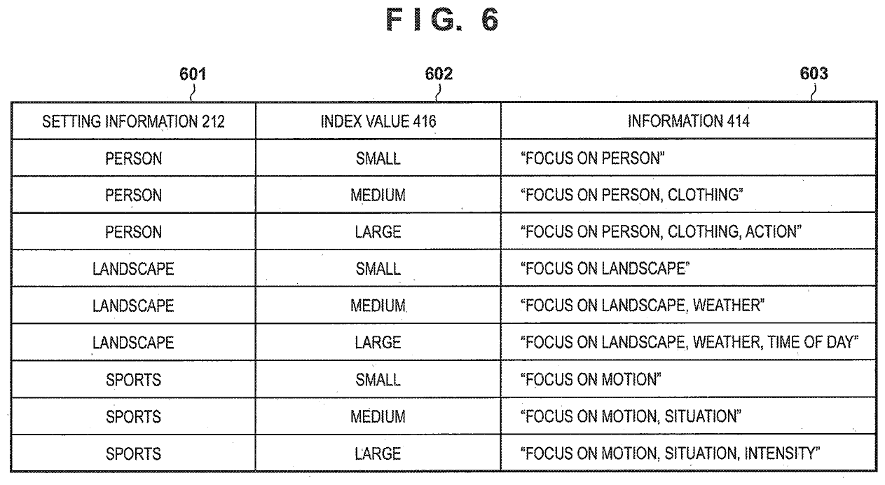

The control information storage unit 403 stores a table holding a plurality of pieces of setting information 212, index values 416, and control information 414. The configuration of the table held by the control information storage unit 403 will be described later with reference to FIG. 6.

The index value 416 is a value representing a ratio of resources of the CPU 102 and the GPU 108 that can be used by the caption generation unit 202. The ratio of resources of the CPU 102 and the GPU 108 that can be used by the caption generation unit 202 changes depending on the settings of the imaging apparatus 100. Therefore, it may be difficult to generate similar captions under a situation where a setting that places a high load on the CPU 102 and the GPU 108 is made and under a situation where a low load setting is made. In the present embodiment, by using the index value 416, the degree of specificity of a generated caption can be changed according to settings of the imaging apparatus 100 (e.g., resolution of the recorded image 211, whether it is single shooting or continuous shooting, etc.). In the present embodiment, description will be given assuming that the index value 416 takes values in three stages of “large”, “medium”, and “small”. “Large” indicates that there are many resources that can be used by the caption generation unit 202, and “small” indicates that there are few resources that can be used by the caption generation unit 202.

That is, these resources represent, for example, a reserve of processing capacity that can be used for generating a caption out of a processing capacity inherent to a processor. Therefore, the index value 416 may be determined based on a shooting setting value after selecting in advance shooting settings that change the load of a processor such as a CPU or a GPU. For example, in the above example, if the resolution of the recorded image 211 exceeds a predetermined value, the index value may be “high”, if the resolution is equal to or less than the predetermined value and it is continuous shooting, the index value may be “medium”, and if the resolution is equal to or less than the predetermined value and it is single shooting, the index value may be “low”. Of course, this is merely an example, and an index value may be predetermined for each setting item and its setting value in this way.

FIG. 6 shows a configuration example of a table held by the control information storage unit 403 in the present embodiment. The table shown in FIG. 6 is composed of three columns.

A column 601 stores values that the setting information 212 can take. In the present embodiment, three types of shooting modes, “person mode”, “landscape mode”, and “sports mode”, are stored as shooting setting information. Of course, this is an example, and as shown in the first embodiment, there is no limitation to the shooting mode and a subject corresponding to a tracking target of an autofocus function or a shutter speed is possible.

A column 602 stores values that the index value 416 can take. In the present embodiment, values in three stages of “large”, “medium”, and “small” are stored in steps.

A column 603 stores the control information 414 that the input control unit 401 outputs to the caption generation unit 202.

After acquiring the setting information 212 and the index value 416, the input control unit 401 refers to the table held by the control information storage unit 403 and searches for a row in which the setting information 212 matches a value in the column 601 and the index value 416 matches a value in the column 602. The control information 414 stored in the column 603 of the corresponding row is output to the caption generation unit 202. In this way, control information including information (character string) indicating items to be focused on in an image in addition to the subject is stored in the control information storage unit 403 in association with the setting information 212 as the index value 416 indicates a larger reserve of processing capacity. The table of FIG. 6 stored in the control information storage unit 403 may be created and stored in advance.

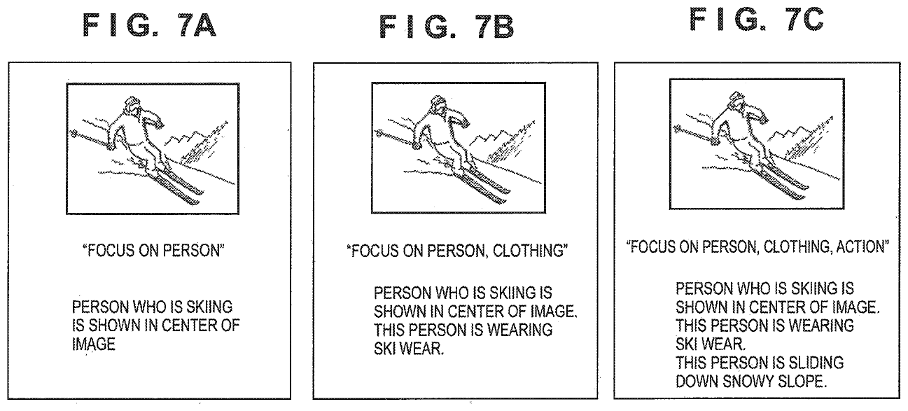

FIG. 7A to FIG. 7C show diagrams representing examples of a relationship among the image 213, the control information 414, and the caption information 215 in the present embodiment. FIG. 7A is an example of a case where the setting information 212 is “person mode” and the index value 416 is “small”. As shown in FIG. 6, at this time, information “focus on person” is used as the control information 414, and a caption “a person who is skiing is shown in the center of the image”. FIG. 7B is an example of a case where the setting information 212 is “person mode” and the index value 416 is “medium”. As shown in FIG. 6, at this time, information “focus on person and clothing” is used as the information 414, and a caption “a person who is skiing is shown in the center of the image. This person is wearing ski wear”. Comparing FIG. 7A and FIG. 7B, a caption explaining the person who is the subject more specifically is generated in FIG. 7B. This is because the control information 414 in FIG. 7B has a larger amount of information and is more specific, so that the caption generation unit 202 spends more calculation resources to generate a caption. Specifically, the word “clothing”, i.e., information, is additionally included in the control information, and a trained model trained to include a description corresponding to the control information “clothing”, for example, “this person is wearing ski wear”, in a caption is used.

Similarly, FIG. 7C is an example of a case where the setting information 212 is “person mode” and the index value 416 is “large”. As shown in FIG. 6, at this time, as the information 414, information “focus on person, clothing, and action” is used, which has an even larger amount of information than in the case of FIG. 7B and is more specific. Therefore, the generated caption is “a person who is skiing is shown in the center of the image. This person is wearing ski wear. This person is sliding down a snowy slope.”, and a caption explaining the person who is the subject even more specifically is generated. This is because the information 414 in FIG. 7C has a larger amount of information and is more specific compared to FIG. 7B, so that the caption generation unit 202 spends more calculation resources to generate the caption. Specifically, the word “action”, i.e., information, is additionally included in the control information, and a trained model trained to include a description corresponding to the control information “action”, for example, “this person is sliding down a snowy slope”, in a caption is used.

As illustrated using FIG. 7A to FIG. 7C, also in the present embodiment, like the first embodiment, a subject is determined based on setting information and a caption related to the subject is generated, so that a caption intended by the user can be generated. In addition, in the present embodiment, by taking calculation resources into account, it is possible to generate a more specific caption according to available resources.

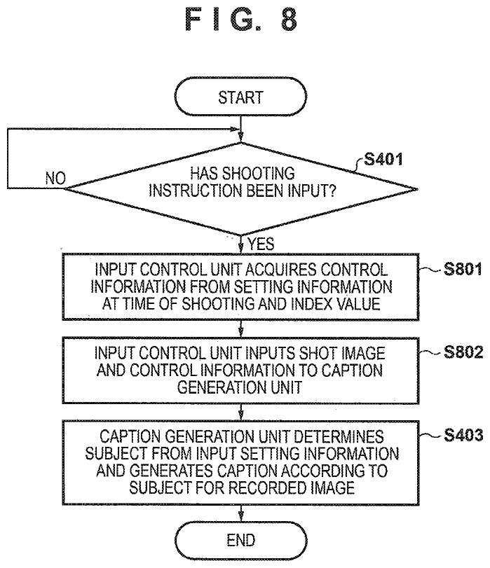

FIG. 8 shows an operation flow in the present embodiment. Here, steps assigned the same numbers as in FIG. 4 are the same as the contents described in FIG. 4, and therefore description thereof will be omitted here. The processing in FIG. 8 may be executed, for example, when initialization processing or the like is completed after power-on and preparations for shooting are completed. Alternatively, it may be started triggered by a shooting instruction, for example, pressing of a release button, and in that case, it may be started from step S801. The processing in FIG. 8 is executed by the CPU 102, but the processing by the caption generation unit 202 may be executed by the GPU 108 or an NPU (not shown) in response to an instruction from the CPU 102.

In step S801, upon receiving the shooting instruction, the CPU 102 acquires the setting information 212 and the index value 416 of the imaging apparatus 100, and based on these pieces of information, acquires information 414 to be input from the control information storage unit 403 to the caption generation unit 202.

In step S802, the CPU 102 inputs the recorded image 211 acquired by the shooting instruction or an image based thereon to the caption generation unit 202 as the image 213. Furthermore, the CPU 102 inputs the information 414 acquired in step S801 to the caption generation unit 202.

In step S403, the CPU 102 or the GPU 108 operates as the caption generation unit 202 and generates a character string serving as a caption according to the input control information 414 and image 213.

With the above, the description of the operation flow of the input control unit 401 and the caption generation unit 202 is ended.

In the above description, the index value 416 has been described as a value representing resources of a processor such as the CPU 102 and the GPU 108, but the index value is not limited to this. The index value 416 may be any value capable of selecting any one from a plurality of pieces of control information stored in the control information storage unit 403. For example, a configuration may be made such that a user explicitly sets the index value 416 using the interface unit 105 of the imaging apparatus 100. By configuring in this way, it is possible to generate a caption with the same degree of specificity regardless of the settings of the imaging apparatus 100. Furthermore, for example, a configuration may be made such that the user can rewrite the table held by the control information storage unit 403 using the interface unit 105 of the imaging apparatus 100. This rewriting may be performed by, for example, an operation of a touch panel integrated with the display unit 106, or an operation from a terminal device connected by communication. By configuring in this way, a caption reflecting the user intention more can be generated.

As described above, the second embodiment can generate high-accuracy captions by using the index value 416 without causing the system of the imaging apparatus 100 to fail.

Preferred embodiments have been described above, but the scope of the claims is not limited to these embodiments, and various modifications and changes are possible within the scope of the gist thereof.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-076872, filed May 2, 2025 which is hereby incorporated by reference herein in its entirety.

What is claimed is:

1. An imaging apparatus comprising:
an imaging device;
at least one memory storing instructions; and
at least one processor that is in communication with the at least one memory and that, when executing the instructions, cooperates with the at least one memory to execute processing, the processing including
generating control information according to a shooting setting of the imaging device; and
generating a caption according to an image shot by the imaging device and the control information.

2. The imaging apparatus according to claim 1,
wherein the shooting setting is a shooting mode, and the processing includes generating information indicating a subject of shooting according to the shooting mode as the control information.

3. The imaging apparatus according to claim 2,
wherein the shooting mode includes a person mode indicating that a subject is a person, a landscape mode indicating that a subject is a landscape, and a sports mode indicating that a subject is a motion of an object.

4. The imaging apparatus according to claim 1,
wherein the shooting setting is a setting of an autofocus function, and
the processing includes generating information indicating a subject of shooting according to a subject of tracking by the autofocus function as the control information.

5. The imaging apparatus according to claim 4,
wherein the setting of the autofocus function includes person priority indicating that the subject of tracking is a person, animal priority indicating that the subject of tracking is an animal, and vehicle priority indicating that the subject of tracking is a vehicle.

6. The imaging apparatus according to claim 1,
wherein the shooting setting is a shutter speed, and
the processing includes generating information indicating a subject of shooting according to the shutter speed as the control information.

7. The imaging apparatus according to claim 6,
wherein the processing includes generating the control information indicating that a subject is a subject of shooting in a case where the shutter speed is slower than a threshold, and generating the control information indicating that a motion of a subject is a subject in a case where the shutter speed is equal to or greater than the threshold.

8. The imaging apparatus according to claim 1,
wherein the processing includes generating the control information according to a shooting setting of the imaging device and an index value indicating a reserve capacity of a processing capacity of the imaging apparatus.

9. The imaging apparatus according to claim 8,
wherein the processing includes generating the control information such that as the reserve capacity of the processing capacity indicated by the index value is larger, items to be focused on in the image increase.

10. The imaging apparatus according to claim 8,
wherein the index value is predetermined in steps according to shooting settings.

11. The imaging apparatus according to claim 10,
wherein the index value is determined according to shooting settings including a setting of a resolution of an image shot by the imaging device and a setting of whether shooting is single shooting or continuous shooting.

12. The imaging apparatus according to claim 8,
wherein the shooting setting is a shooting mode, and
the processing includes generating information indicating a subject of shooting according to the shooting mode and the index value as the control information.

13. The imaging apparatus according to claim 8,
wherein the shooting setting is a subject of tracking by an autofocus function, and
the processing includes generating information indicating a subject of shooting according to the subject of tracking and the index value as the control information.

14.

13. The imaging apparatus according to claim 8,
wherein the shooting setting is a shutter speed, and
the processing includes generating information indicating a subject of shooting according to the shutter speed and the index value as the control information.

15. The imaging apparatus according to claim 8,
wherein the processing further includes holding the control information in association with the shooting setting and the index value, and
the held control information is rewriteable by a user.

16. The imaging apparatus according to claim 1,
wherein the processing further includes associating and saving an image shot by the imaging device and a caption generated with the image as an input.

17. The imaging apparatus according to claim 1,
wherein the processing includes processing using a trained model of machine learning, with an image shot by the imaging device and generated control information as inputs and the caption as an output.

18. The imaging apparatus according to claim 1,
wherein the processing includes inputting an image shot by the imaging device and generated control information to a trained model of machine learning outside the imaging apparatus, and acquiring a caption output from the trained model.

19. A non-transitory computer-readable storage medium storing a program that, when loaded and executed by a computer, causes the computer to execute processing, the processing including:
generating control information according to a shooting setting of a camera; and
generating a caption according to an image shot by the camera and the control information.

20. A control method of an imaging apparatus, comprising:
generating control information according to a shooting setting of a camera; and
generating a caption according to an image shot by the camera and the control information.
